(19) United States
(12) Patent Application Publication
(10) Pub. No.: US 2008/0032100 A1
(43) Pub. Date: Feb. 7, 2008

(54) Multilayer Information Recording Medium and Production Method Therefor, and Photosensitive Adhesive Sheet

(75) Inventors: Masahiko Tsukuda, Osaka (JP); Morio Tomiyama, Nara (JP); Keiji Nishikiori, Kyoto (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi, Osaka (JP)

(21) Appl. No.: 11/574,858

(22) PCT Filed: Sep. 22, 2005
(86) PCT No.: PCT/JP05/17519

§ 371 Date: Mar. 7, 2007

(30) Foreign Application Priority Data
Sep. 24, 2004 (JP) 2004-276830

(51) Int. Cl. G11B 7/26; C09J 133/00; C09J 7/02; G11B 7/24

(52) U.S. Cl. 428/212; 156/230; 428/354

(57) ABSTRACT

A method is provided for producing a multilayer information recording medium including two or more information recording layers and a space layer provided between adjacent information recording layers. The method includes the steps of: providing a photosensitive adhesive sheet (300) containing an ultraviolet curable oligomer and an adhesive polymer on a predetermined information recording layer (102), attaching a stamper substrate (111) having an uneven surface as an information surface to the photosensitive adhesive sheet so as to transfer information of the stamper substrate to the photosensitive adhesive sheet, curing the photosensitive adhesive sheet after the transfer of the information so as to cause the photosensitive adhesive sheet to be the space layer (103), and peeling off the stamper substrate from the space layer and subsequently forming another information recording layer (104) on the space layer. The photosensitive adhesive sheet has a layered structure including a first resin film (301) and a second resin film (302) as outermost films, and the second resin film contacting the stamper substrate has an ultraviolet curable oligomer content (% by weight) higher than that of the first resin film contacting the predetermined information recording layer.

### TECHNICAL FIELD

The present invention relates to a multilayer information recording medium capable of recording and/or reproducing information, such as audio, video and the like, as a digital signal, and including a plurality of information recording layers to be able to record and/or reproduce a large amount of information, and a method for producing the same. Also, the present invention relates to a photosensitive adhesive sheet for use in the production method.

### BACKGROUND ART

In recent years, information recording media to and from which information is optically recorded and reproduced have been widespread as industrial products and consumer products with the advance of research thereof. Particularly, information recording media, such as CDs (Compact Discs), DVDs (Digital Versatile Discs), and the like, are used widely. These information recording media have, for example, a structure in which a metal thin film and a protective layer are provided in this order on an uneven surface of a transparent base plate. The uneven surface of the transparent base plate is an information surface including pits, grooves, or the like. The protective layer serves to protect the recording film or the like from moisture in the atmosphere and the like. Information recorded on an information recording medium is reproduced, for example, by irradiating the uneven surface of the metal thin film with laser light, and detecting a change in light amount of reflected light.

The information recording medium is produced, for example, as follows. A transparent base plate is formed by injection molding using a metal die (also called a stamper) or the like having an uneven surface. Next, an information recording layer including a recording film composed of, for example, a metal thin film is formed on an uneven surface of the transparent base plate by vapor deposition, sputtering, or the like. Thereafter, the information recording layer is coated with an ultraviolet curable resin or the like to form a protective layer.

In recent years, as there has been a further increasing demand for a larger capacity of an information recording medium, efforts have been made to further increase the density of the information recording medium. For example, a DVD having a two-layer structure has been proposed in which two information recording layers are provided via a space layer having a thickness of several tens of micrometers. Also, in recent years, as digital high-definition broadcasting and the like have been widespread, a Blu-ray disc, for example, has been proposed as a next-generation information recording medium that has a larger capacity than that of DVD. The Blu-ray disc has a narrower track pitch and a smaller pit size on a recording film than those of DVD. Therefore, for the Blu-ray disc, a smaller spot of reading laser (wavelength: 400 nm to 420 nm) than that of DVD is required. However, a decrease in the spot diameter is likely to lead to a serious failure in reproduction even due to a small tilt of the disc. To compensate with the drawback, in the Blu-ray disc, a protective layer provided on a laser entering side has a thickness as thin as about 0.1 mm.

As a method for further increasing the capacity of a Blu-ray disc, multiple information recording layers are provided. A Blu-ray disc including a plurality of information recording layers can be produced by a production method disclosed in, for example, Patent Document 1. For example, an information recording layer is formed on a base plate having pits and/or grooves (i.e., a base plate having an uneven surface) by deposition, sputtering, or the like. Next, an optical curable transfer sheet is attached to the information recording layer. Next, a stamper having an uneven surface is pressed against the optical curable transfer sheet. Next, the optical curable transfer sheet is cured by irradiation with ultraviolet light, and the stamper is peeled off from the cured optical curable transfer sheet. The cured optical curable transfer sheet serves as a space layer. By repeatedly performing the formation of an information recording layer and the formation of a space layer a desired number of times, a Blu-ray disc having a plurality of information recording layers can be obtained.

Patent Document 1: JP 2003-272244A

### DISCLOSURE OF INVENTION

### Problem to be Solved by the Invention

In the above-described production method, it is necessary to achieve both high adhesiveness of an optical curable transfer sheet (space layer) with respect to an information recording layer and high peelability of a stamper with respect to the optical curable transfer sheet (space layer), so as to produce a multilayer information recording medium easily. However, the high adhesiveness and the high peelability are mutually contradictory, and therefore, it is considerably difficult to achieve both of these properties in the conventional art.

An object of the present invention is to facilitate production of a multilayer information recording medium having a plurality of information recording layers.

### Means for Solving Problem

A first method of the present invention is provided for producing a multilayer information recording medium including two or more information recording layers and a space layer provided between adjacent information recording layers. The method includes the steps of providing a photosensitive adhesive sheet containing an ultraviolet curable oligomer and an adhesive polymer on a predetermined information recording layer, attaching a stamper substrate having an uneven surface as an information surface to the photosensitive adhesive sheet so as to transfer information of the stamper substrate plate to the photosensitive adhesive sheet, curing the photosensitive adhesive sheet after the transfer of the information so as to cause the photosensitive adhesive sheet to be the space layer, and peeling off the stamper substrate from the space layer and subsequently forming another information recording layer on the space layer. The photosensitive adhesive sheet has a layered structure including a first resin film and a second resin film as outermost films, and the second resin film contacting the stamper substrate has an ultraviolet curable oligomer content (% by weight) higher than that of the first resin film contacting the predetermined information recording layer.

A second method of the present invention is provided for producing a multilayer information recording medium including two or more information recording layers and a space layer provided between adjacent information recording layers. The method includes the steps of providing a photosensitive adhesive sheet containing an ultraviolet curable oligomer and an adhesive polymer on a predetermined information recording layer, attaching a stamper substrate having an uneven surface as an information surface to the photosensitive adhesive sheet so as to transfer information of the stamper substrate to the photosensitive adhesive sheet, curing the photosensitive adhesive sheet after the transfer of the information so as to cause the photosensitive adhesive sheet to be the space layer, and peeling off the stamper substrate from the space layer and subsequently forming another information recording layer on the space layer. The photosensitive adhesive sheet has a layered structure including a first resin film and a second resin film as outermost films, and the first resin film contacting the predetermined information recording layer has an adhesive polymer content (% by weight) higher than that of the second resin film contacting the stamper substrate.

A first photosensitive adhesive sheet of the present invention is provided for use in production of a multilayer information recording medium including two or more information recording layers and a space layer provided between adjacent information recording layers. The photosensitive adhesive sheet includes a first resin film as one outermost film, and a second resin film as the other outermost film. The first resin film and the second resin film both contain an ultraviolet curable oligomer and an adhesive polymer, and the second resin film has an ultraviolet curable oligomer content (% by weight) higher than that of the first resin film.

A second photosensitive adhesive sheet of the present invention is provided for use in production of a multilayer information recording medium including two or more information recording layers and a space layer provided between adjacent information recording layers. The photosensitive adhesive sheet includes a first resin film as one outermost film, and a second resin film as the other outermost film. The first resin film and the second resin film both contain an ultraviolet curable oligomer and an adhesive polymer, and the first resin film has an adhesive polymer content (% by weight) higher than that of the second resin film.

A first multilayer information recording medium of the present invention includes a base plate, a first information recording layer provided on the base plate, a space layer provided on the first information recording layer, and containing an ultraviolet curable oligomer and an adhesive polymer, and a second information recording layer provided on the space layer. The space layer has a layered structure including a first outermost film contacting the first information recording layer and a second outermost film contacting the second information recording layer, and the second outermost film has an ultraviolet curable oligomer content (% by weight) higher than that of the first outermost film.

A second multilayer information recording medium of the present invention includes a base plate, a first information recording layer provided on the base plate, a space layer provided on the first information recording layer, and containing an ultraviolet curable oligomer and an adhesive polymer, and a second information recording layer provided on the space layer. The space layer has a layered structure including a first outermost film contacting the first information recording layer and a second outermost film contacting the second information recording layer, and the first outermost film has an adhesive polymer content (% by weight) higher than that of the second outermost film.

### EFFECTS OF THE INVENTION

According to the present invention, it is possible to facilitate production of a multilayer information recording medium.

### BRIEF DESCRIPTION OF DRAWINGS

FIG. 1 is a partial cross-sectional view of an exemplary photosensitive adhesive sheet according to Embodiment 1 or 2.

FIG. 2 is a partial cross-sectional view of another exemplary photosensitive adhesive sheet according to Embodiment 1.

FIG. 3 is a schematic diagram illustrating an exemplary photosensitive adhesive sheet producing method according to Embodiment 3.

FIG. 4 is a graph illustrating a relationship between a thickness and a variation in thickness of an exemplary photosensitive adhesive sheet.

FIG. 5A is a partial cross-sectional view for describing an exemplary method for producing a multilayer information recording medium of Embodiment 4.

FIG. 5B is a partial cross-sectional view for describing the exemplary method for producing a multilayer information recording medium of Embodiment 4.

FIG. 5C is a partial cross-sectional view for describing the exemplary method for producing a multilayer information recording medium of Embodiment 4.

FIG. 5D is a partial cross-sectional view for describing the exemplary method for producing a multilayer information recording medium of Embodiment 4.

FIG. 5E is a partial cross-sectional view for describing the exemplary method for producing a multilayer information recording medium of Embodiment 4.

FIG. 5F is a partial cross-sectional view for describing the exemplary method for producing a multilayer information recording medium of Embodiment 4.

FIG. 5G is a partial cross-sectional view for describing the exemplary method for producing a multilayer information recording medium of Embodiment 4.

FIG. 6 is a partial cross-sectional view for describing an exemplary information recording layer.

FIG. 7A is a partial cross-sectional view for describing an exemplary method for producing a multilayer information recording medium of Embodiment 5.

FIG. 7B is a partial cross-sectional view for describing the exemplary method for producing a multilayer information recording medium of Embodiment 5.

FIG. 7C is a partial cross-sectional view for describing the exemplary method for producing a multilayer information recording medium of Embodiment 5.

FIG. 7D is a partial cross-sectional view for describing the exemplary method for producing a multilayer information recording medium of Embodiment 5.

FIG. 7E is a partial cross-sectional view for describing the exemplary method for producing a multilayer information recording medium of Embodiment 5.

FIG. 8A is a partial cross-sectional view for describing an exemplary method for producing a multilayer information recording medium of Embodiment 6.

FIG. 8B is a partial cross-sectional view for describing the exemplary method for producing a multilayer information recording medium of Embodiment 6.

FIG. 8C is a partial cross-sectional view for describing the exemplary method for producing a multilayer information recording medium of Embodiment 6.

FIG. 8D is a partial cross-sectional view for describing the exemplary method for producing a multilayer information recording medium of Embodiment 6.

FIG. 8E is a partial cross-sectional view for describing the exemplary method for producing a multilayer information recording medium of Embodiment 6.

FIG. 8F is a partial cross-sectional view for describing the exemplary method for producing a multilayer information recording medium of Embodiment 6.

FIG. 8G is a partial cross-sectional view for describing the exemplary method for producing a multilayer information recording medium of Embodiment 6.

FIG. 9A is a partial cross-sectional view for describing an exemplary method for producing a multilayer information recording medium of Embodiment 7.

FIG. 9B is a partial cross-sectional view for describing the exemplary method for producing a multilayer information recording medium of Embodiment 7.

FIG. 9C is a partial cross-sectional view for describing the exemplary method for producing a multilayer information recording medium of Embodiment 7.

FIG. 9D is a partial cross-sectional view for describing the exemplary method for producing a multilayer information recording medium of Embodiment 7.

FIG. 9E is a partial cross-sectional view for describing the exemplary method for producing a multilayer information recording medium of Embodiment 7.

FIG. 9F is a partial cross-sectional view for describing the exemplary method for producing a multilayer information recording medium of Embodiment 7.

FIG. 9G is a partial cross-sectional view for describing the exemplary method for producing a multilayer information recording medium of Embodiment 7.

FIG. 10A is a partial cross-sectional view of an exemplary multilayer information recording medium according to Embodiment 8.

FIG. 10B is an enlarged view of a portion X of FIG. 10A.

### DESCRIPTION OF THE INVENTION

101 base plate
102 first information recording layer
104 second information recording layer
106 third information recording layer
108 fourth information recording layer
103 first space layer (space layer)
105 second space layer (space layer)
107 third space layer
109 cover layer
110 pressure roller
111, 211 stamper substrate
112 ultraviolet lamp
211a resin substrate
211b metal film
300 photosensitive adhesive sheet
304 protective sheet
305 protective sheet
301 first resin film
302 second resin film
502 roll
503 rotation roller
504 resin supply nozzle
505 resin supply nozzle
506 dryer
510 rotation roller
511 dryer

### DESCRIPTION OF THE INVENTION

In an example of the first method for producing a multilayer information recording medium of the present invention, the first resin film preferably has an adhesive polymer content (% by weight) higher than that of the second resin film. This is because the stamper substrate can be peeled off more satisfactorily while securing the adhesiveness between the cured photosensitive adhesive sheet and the predetermined information recording layer.

In an example of the second method for producing a multilayer information recording medium of the present invention, the second resin film preferably has an ultraviolet curable oligomer content (% by weight) higher than that of the first resin film. This is because the stamper substrate can be peeled off more satisfactorily while securing the adhesiveness between the cured photosensitive adhesive sheet and the predetermined information recording layer.

In an example of the first method for producing a multilayer information recording medium of the present invention, the ultraviolet curable oligomer content of the second resin film is appropriately, for example, 30% by weight or more. In this case, the ultraviolet curable oligomer content of the first resin film may be, for example, less than 30% by weight.

In an example of the first method for producing a multilayer information recording medium of the present invention, the ultraviolet curable oligomer content of the second resin film more preferably is 40% by weight or more and 60% by weight or less. In this case, the ultraviolet curable oligomer content of the first resin film is preferably 10% by weight or more and less than 30% by weight. In other words, the difference between the ultraviolet curable oligomer content of the second resin film and the ultraviolet curable oligomer content of the first resin film preferably is 10% by weight or more. This is because the stamper substrate can be peeled off more satisfactorily while securing the adhesiveness between the cured photosensitive adhesive sheet and the predetermined information recording layer.

The photosensitive adhesive sheet preferably has a two-layer structure. This is because, if the number of layers is smaller, it is possible to further suppress degradation in incident light due to refraction of the light.

The photosensitive adhesive sheet preferably has a thickness of 30 μm or less.

The stamper substrate preferably is transparent with respect to light used for curing of the photosensitive adhesive sheet. Such a stamper substrate may be formed, for example, only of a resin, or may have a structure including a resin substrate and a metal film provided thereon. The metal film is transparent with respect to light used for curing of the photosensitive adhesive sheet. In this case, the information surface of the stamper substrate is one surface of the metal film. As used herein, “transparent with respect to light used for curing of a photosensitive adhesive sheet” indicates that light (e.g., light having a wavelength of 365 nm) used for curing of a photosensitive adhesive sheet has a transmittance of 25% or more and 100% or less.

In an example of the first method for producing a multilayer information recording medium of the present invention, the method may further include forming a cover layer after the other information recording layer is formed on the space layer. The cover layer may be made of the same photosensitive adhesive sheet as that which is used for formation of the space layer, for example. As used herein, “the same photosensitive adhesive sheet” is not limited to that which has the same components and the same ratio of the components as those of the photosensitive adhesive sheet used for forming the space layer. When a photosensitive adhesive sheet includes a first resin film and a second resin film both of which contain an ultraviolet curable oligomer and an adhesive polymer, and in which the second resin film has an ultraviolet curable oligomer content (% by weight) higher than that of the first resin film, the photosensitive adhesive sheet is included in “the same photosensitive adhesive sheet” even if it has a different type of ultraviolet curable oligomer and/or adhesive polymer, or a different content (% by weight) of each component.

In the cover layer forming step, the photosensitive adhesive sheet preferably is disposed so that the first resin film of the photosensitive adhesive sheet faces the other information recording layer. When the photosensitive adhesive sheet is disposed in this manner, by curing of the photosensitive adhesive sheet, a major surface of the second resin film having a higher ultraviolet curable oligomer content (% by weight) serves as one major surface of the multilayer information recording medium. The cured second resin film containing a large amount of an ultraviolet curable oligomer is hard, thereby making it possible to provide a multilayer information recording medium which is unlikely to be scratched.

Hereinafter, embodiments of the present invention will be described with reference to the accompanying drawings.

### EMBODIMENT 1

In Embodiment 1, an exemplary photosensitive adhesive sheet will be described. The photosensitive adhesive sheet of this embodiment can be used as a material for a space layer or a cover layer in a method for producing a multilayer information recording medium described below.

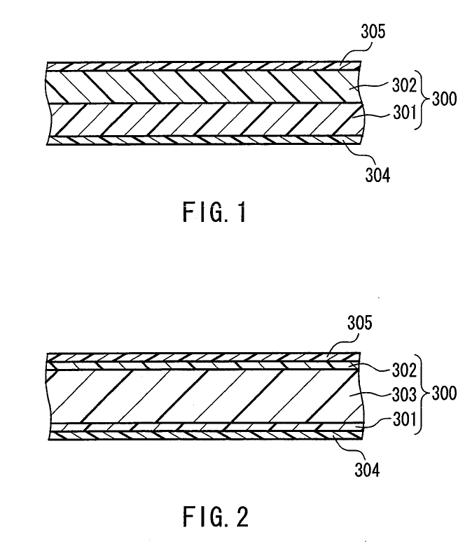

FIG. 1 illustrates a partial cross-sectional view of an exemplary photosensitive adhesive sheet with a protective sheet. As illustrated in FIG. 1, the photosensitive adhesive sheet 300 of this embodiment has a layered structure including a first resin film 301 and a second resin film 302. Since the photosensitive adhesive sheet 300 of FIG. 1 has the two-layer structure, the first resin film 301 and the second resin film 302 are both outermost films. In FIGS. 1, 304 and 305 indicate protective sheets, and the photosensitive adhesive sheet 300 is used after at least one of the protective sheets 304 and 305 is peeled off.

The first resin film 301 and the second resin film 302 both include an adhesive polymer and an ultraviolet curable oligomer. There is not a particular limitation on the adhesive polymer and, for example, an acrylic copolymer or the like is used.

In the photosensitive adhesive sheet 300, the second resin film 302 has an ultraviolet curable oligomer content (% by weight) higher than that of the first resin film 301. The ultraviolet curable oligomer is caused to have a reticulated structure by irradiation with light, thereby forming a crosslinked structure, so that the elasticity modulus increases and the adhesiveness decreases. Therefore, the second resin film 302 including a larger amount of the ultraviolet curable oligomer has a larger degree of decrease in adhesive force than that of the first resin film 301.

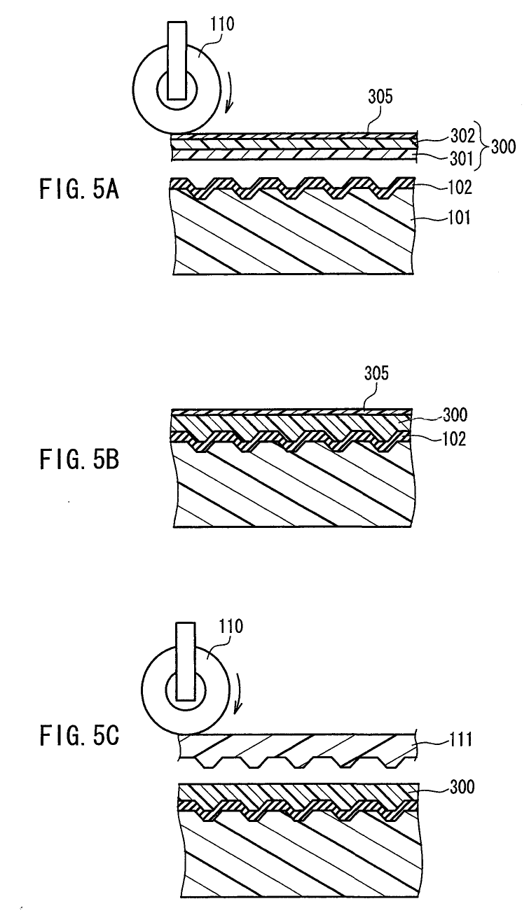

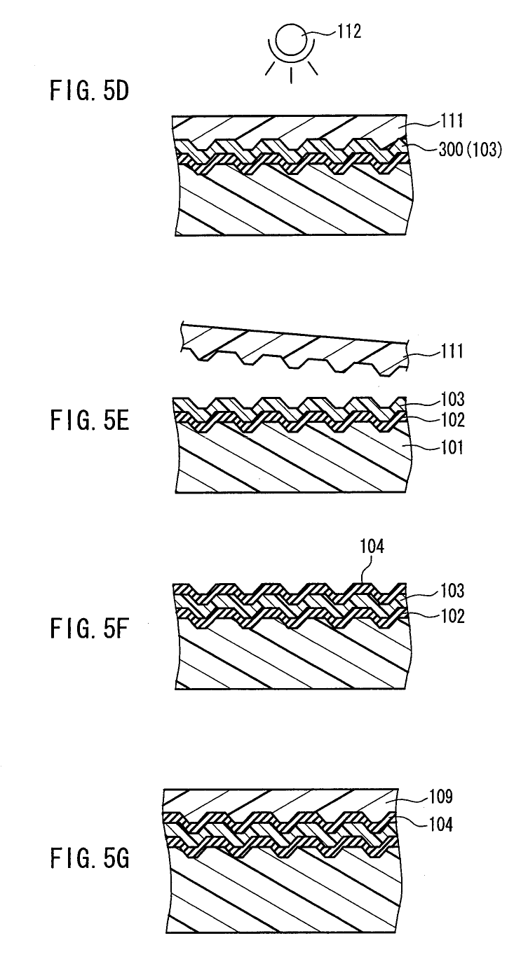

Therefore, in the method for producing the multilayer information recording medium as described below, if the photosensitive adhesive sheet 300 is used so that the second resin film 302 contacts a stamper substrate 111 and the first resin film 301 contacts a first information recording layer 102, the peelability of the stamper substrate 111 with respect to the second resin film 302 can be increased while securing the adhesiveness between the first resin film 301 and the first information recording layer 102. In other words, the stamper substrate 111 can be peeled off satisfactorily while securing the adhesiveness between the cured photosensitive adhesive sheet 300 and the first information recording layer 102. Thereby, a multilayer information recording medium having a plurality of information recording layers can be produced easily (see, for example, FIGS. 5A to 5C).

FIG. 2 illustrates a partial cross-sectional view of another exemplary photosensitive adhesive sheet with a protective sheet. The photosensitive adhesive sheet of FIG. 2 is different from the photosensitive adhesive sheet having a two-layer structure of FIG. 1 in that the photosensitive adhesive sheet of FIG. 2 has a three-layer structure, and in other respects, is similar to the photosensitive adhesive sheet of FIG. 1.

A material for a film 303 which is provided between the first resin film 301 and the second resin film 302 is not particularly limited, as long as it is sufficiently transparent with respect to incident light, and the adhesiveness is high with respect to the first resin film 301 and the second resin film 302. As the material for the film 303, for example, a material totally different from the first resin film 301 and the second resin film 302 may be used, however, for example, the same material as the first resin film 301 or the second resin film 302 preferably is used in view of the above-described adhesiveness, a degradation of incident light due to a difference in refractive index, and the like.

Note that the above-described “the same material” is not limited to one having the same components and the same ratio of the components as those of the first resin film 301 or the second resin film 302. For example, a material having different component contents (% by weight) is included in the above-described “the same material”.

The number of films constituting the photosensitive adhesive sheet 300 is not particularly limited, and preferably is small in view of the degradation in incident light due to refraction of the light. Therefore, the photosensitive adhesive sheet 300 preferably has a two-layer structure.

The ultraviolet curable oligomer content of the second resin film 302 is not particularly limited, as long as it is higher than that of the first resin film 301. For example, the content preferably is 30% by weight or more. In this case, the ultraviolet curable oligomer content of the first resin film 301 may be, for example, less than 30% by weight.

The ultraviolet curable oligomer content of the second resin film 302 preferably is 40% by weight or more and 60% by weight or less. In this case, the ultraviolet curable oligomer content of the first resin film 301 is preferably 10% by weight or more and 30% by weight or less. In other words, the difference between the ultraviolet curable oligomer content of the second resin film and the ultraviolet curable oligomer content of the first resin film preferably is 10% by weight or more. This is because the stamper substrate 111 can be peeled off more satisfactorily while securing the adhesiveness between the first resin film 301 and the first information recording layer 102.

The first resin film 301 and the second resin film 302 each may contain a small amount of a curing initiator or other additives as a third component in addition to the ultraviolet curable oligomer and the adhesive polymer. Also, the first resin film 301 and the second resin film 302 each may contain a third resin other than the ultraviolet curable oligomer and the adhesive polymer.

The adhesive polymer contents (% by weight) of the first resin film 301 and the second resin film 302 are not particularly limited. For example, the adhesive polymer content (% by weight) of the first resin film 301 may be equal to the adhesive polymer content (% by weight) of the second resin film 302. However, the adhesive polymer content (% by weight) of the first resin film 301 more preferably is higher than the adhesive polymer content (% by weight) of the second resin film 302. The reason is as follows.

When the adhesive polymer content (% by weight) of the first resin film 301 is higher than the adhesive polymer content (% by weight) of the second resin film 302, the adhesion strength between the first resin film 301 and the first information recording layer 102 is higher than the adhesion strength between the second resin film 302 and the stamper substrate 111. Therefore, since the adhesiveness decreases due to the ultraviolet curable oligomer during curing, the stamper substrate 111 can be peeled off more satisfactorily while securing the adhesiveness between the cured first resin film 301 and the first information recording layer 102.

### EMBODIMENT 2

In Embodiment 2, another exemplary photosensitive adhesive sheet of the present invention will be described. The photosensitive adhesive sheet of this embodiment also can be used as a material for a space layer or a cover layer in a method for producing a multilayer information recording medium described below, as with the photosensitive adhesive sheet of Embodiment 1.

The photosensitive adhesive sheet of this embodiment has a layered structure similar to that of the photosensitive adhesive sheet of Embodiment 1, and also will be described with reference to FIG. 1.

As illustrated in FIG. 1, in the photosensitive adhesive sheet 300 of this embodiment, the adhesive polymer content (% by weight) of the first resin film 301 is higher than the adhesive polymer content (% by weight) of the second resin film 302. However, the ultraviolet curable oligomer content (% by weight) of the second resin film 302 does not necessarily need to be higher than the ultraviolet curable oligomer content (% by weight) of the first resin film 301. In this respect, the photosensitive adhesive sheet 300 of this embodiment is different from the photosensitive adhesive sheet of Embodiment 1.

In the photosensitive adhesive sheet 300 of this embodiment, the adhesive polymer content (% by weight) of the first resin film 301 is higher than the adhesive polymer content (% by weight) of the second resin film 302, and therefore, the adhesion strength between the first resin film 301 and the first information recording layer 102 is higher than the adhesion strength between the second resin film 302 and the stamper substrate 111. As a result, the stamper substrate 111 can be peeled off satisfactorily while securing the adhesiveness between the cured first resin layer 301 and the first information recording layer 102 (see, for example, FIGS. 5A to 5E).

The adhesive polymer content of the first resin film 301 is not particularly limited, as long as it is higher than that of the second resin film 302. For example, it preferably is 60% by weight or more.

The adhesive polymer content (% by weight) of the first resin film 301 more preferably is 70% by weight or more and 90% by weight or less. In this case, the adhesive polymer content (% by weight) of the second resin film 302 preferably is 40% by weight or more and 60% by weight or less. This is because the stamper substrate 111 can be peeled off more satisfactorily while securing the adhesiveness between the cured first resin film 301 and the first information recording layer 102.

Also, in the photosensitive adhesive sheet 300 of this embodiment, as in the photosensitive adhesive sheet of Embodiment 1, the first resin film 301 and the second resin film 302 may each contain a curing initiator or other additives as a third component in addition to the ultraviolet curable oligomer and the adhesive polymer. Also, the first resin film 301 and the second resin film 302 each may contain a third resin other than the ultraviolet curable oligomer and the adhesive polymer.

### EMBODIMENT 3

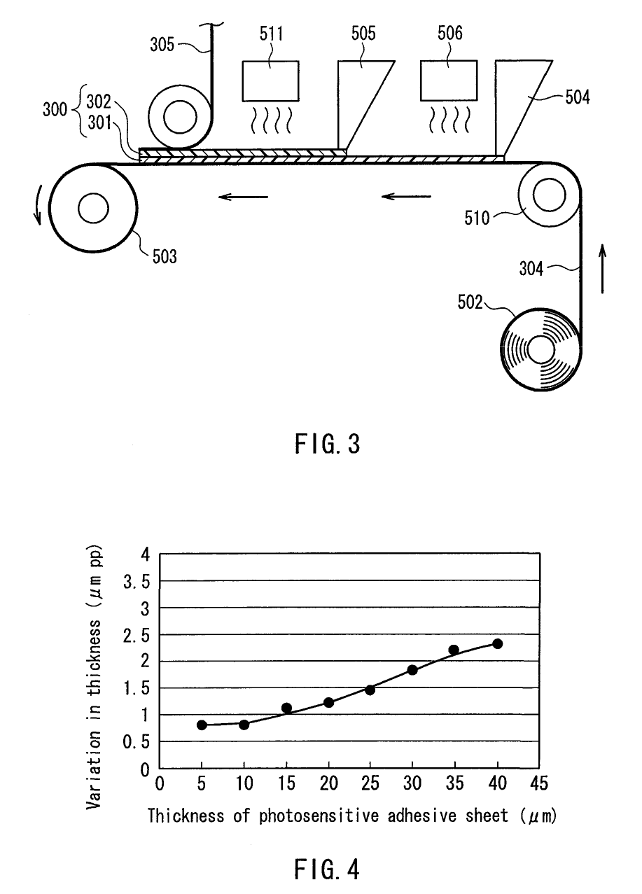

In Embodiment 3, an exemplary method for producing the photosensitive adhesive sheet 300 of Embodiment 1 will be described with reference to FIG. 3.

FIG. 3 is a schematic diagram illustrating an exemplary method for producing a photosensitive adhesive sheet. A protective sheet 304 wound around a roll 502 is unwound from the roll 502, is passed on a rotation roller 510, and is wound by a rotation roller 503. During this time, the first resin film 301 and the second resin film 302 are formed in this order on the protective sheet 304. Next, the protective sheet 305 is attached to the second resin film 302, and the resultant photosensitive adhesive sheet 300 with protective sheets on both sides thereof is wound around the rotation roller 503. The rotation speed or the like of the rotation roller 503 is adjusted so that the protective sheet 304 is not bowed between the rotation roller 510 and the rotation roller 503.

More specifically, a resin-containing coating A is supplied from a supply nozzle 504 onto the protective sheet 304 fed from the roll 502. The resin-containing coating A contains a resin composition a and a solvent for viscosity adjustment. The resin-containing coating A applied to the protective sheet 304 has a thickness that is determined based on a gap between the protective sheet 304 and the resin supply nozzle 504, a supply amount of the resin-containing coating A, and the like. Next, the resin-containing coating applied on the protective sheet 304 is heated with a dryer 506 so that the solvent is evaporated from the resin-containing coating A. Due to the evaporation of the solvent, the applied resin-containing coating A becomes the first resin film 301.

Next, a resin-containing coating B is applied from a resin supply nozzle 505 onto the first resin film 301. The resin-containing coating B contains a resin composition b and a solvent for viscosity adjustment. The applied resin-containing coating B has a thickness that is determined based on a gap between the first resin film 301 and the resin supply nozzle 505, a supply amount of the resin-containing coating B, and the like. Next, the applied resin-containing coating B is heated with a dryer 511 so that the solvent is evaporated from the resin-containing coating B. Due to the evaporation of the solvent, the applied resin-containing coating B becomes the second resin film 302.

Finally, the protective sheet 305 is attached to the second resin film 302, thereby obtaining the photosensitive adhesive sheet 300 with protective sheets on both sides thereof. The resultant photosensitive adhesive sheet 300 is wound around the rotation roller 503.

The resin composition a and the resin composition b both contain an adhesive polymer and an ultraviolet curable oligomer, and optionally, an additive, such as a curing initiator or the like. The ultraviolet curable oligomer content (% by weight) of the resin composition b is higher than that of the resin composition a. Therefore, the ultraviolet curable oligomer content (% by weight) of the second resin film 302 is higher than the ultraviolet curable oligomer content (% by weight) of the first resin film 301.

The solvent contained in the resin-containing coating A and the resin-containing coating B is not particularly limited. For example, toluene, methyl ethyl ketone (MEK), or the like is used.

The material for the protective sheets 304 and 305 is not particularly limited. For example, polyethylene terephthalate (PET), polyethylene, or the like is used.

Next, a relationship between a thickness of a photosensitive adhesive sheet produced by the above-described producing method, and a variation in the thickness, will be described.

FIG. 4 is a graph illustrating a relationship between the “thickness” of the photosensitive adhesive sheet and the “variation in the thickness”. In FIG. 4, the “variation in the thickness” is the absolute value of a difference between a largest thickness and a smallest thickness, i.e., a PEAK-to-PEAK value.

As illustrated in FIG. 4, when the thickness of the photosensitive adhesive sheet is increased, the variation in the thickness becomes larger. This result is considered to be caused because application irregularity increases and/or dryness irregularity increases with an increase in the amount of an applied resin.

The above-described variation in the thickness, when a photosensitive adhesive sheet is used as a material for a space layer of a multilayer information recording medium, leads to a variation in the thickness of the space layer. The variation in the thickness of the space layer increases the aberration of laser light emitted toward the recording film and converged by a condenser lens. The increase of the aberration leads to an adverse influence on the quality of a reproduced signal. For example, when a reproduction head employing a condenser lens having a numerical aperture (NA) of 0.85 is used for reproduction of information recorded on a Blu-ray disc or the like, the adverse influence of the increase of the aberration on the quality of a reproduced signal is considerably large. An upper limit of a tolerable variation in thickness is considered to be about 2 μm. Therefore, according to the result of FIG. 4, the thickness of the photosensitive adhesive sheet used as a material for the space layer preferably is 30 μm or less.

### EMBODIMENT 4

In Embodiment 4, an exemplary method for producing a multilayer information recording medium of the present invention will be described. In the method for producing a multilayer information recording medium of this embodiment, the photosensitive adhesive sheet 300 described with reference to FIG. 1 is used.

FIGS. 5A to 5G are partial cross-sectional views for describing the exemplary method for producing a multilayer information recording medium of this embodiment. A multilayer information recording medium produced by the method for producing a multilayer information recording medium of this embodiment has two information recording layers.

In the method for producing a multilayer information recording medium of this embodiment, initially, as illustrated in FIG. 5A, the first information recording layer 102 is formed on a base plate 101. The material for the base plate 101 is not particularly limited. For example, polycarbonate or the like is used.

Next, the protective sheet 304 is peeled off from the photosensitive adhesive sheet 300 (see FIG. 1), and the photosensitive adhesive sheet 300 is attached to the first information recording layer 102. The first resin film 301 and the second resin film 302 constituting the photosensitive adhesive sheet 300 both contain an ultraviolet curable oligomer. Next, the photosensitive adhesive sheet 300 is pressed against the first information recording layer 102 using a pressure roller 110 (see FIG. 5A). When the photosensitive adhesive sheet 300 is thus pressed, the photosensitive adhesive sheet 300 is deformed in accordance with the uneven surface of the first information recording layer 102 so that the photosensitive adhesive sheet 300 is attached tightly to the first information recording layer 102 (see FIG. 5B).

Next, the protective sheet 305 is peeled off from the photosensitive adhesive sheet 300 (see FIG. 5B). Next, as illustrated in FIG. 5C, the stamper substrate 111 having an uneven surface as information to be transferred is attached tightly to the photosensitive adhesive sheet 300. Thereafter, the stamper substrate 111 is pressed using the pressure roller 110. Thereby, the photosensitive adhesive sheet 300 is deformed in accordance with the uneven surface of the stamper substrate 111 so that the information is transferred to the photosensitive adhesive sheet 300. The stamper substrate 111 is formed of, for example, polycarbonate, and is transparent with respect to ultraviolet light.

Note that, as the material for the stamper substrate 111, polyolefin may be used instead of polycarbonate. Polyolefin has a satisfactory level of peelability with respect to a photosensitive adhesive sheet. Also, polyolefin has a satisfactory level of formability, and therefore, an information surface having an uneven shape can be easily formed. Examples of polyolefin include cycloolefin, which is made of cyclopentadiene. Note that polycarbonate is more preferable than polyolefin in terms of cost.

Next, as illustrated in FIG. 5D, the photosensitive adhesive sheet 300 is irradiated via the stamper substrate 111 with ultraviolet light using an ultraviolet lamp 112 (e.g., a halogen lamp, etc.), to cure the photosensitive adhesive sheet 300. By curing, the photosensitive adhesive sheet 300 becomes a space layer 103. Thereafter, as illustrated in FIG. 5E, the stamper substrate 111 is peeled off from the space layer 103. The adhesive force of the photosensitive adhesive sheet 300 is reduced due to curing. Particularly, in the second resin film 302 having an ultraviolet curable oligomer content (% by weight) higher than that of the first resin film 301, the degree of the reduction of the adhesive force is larger than that of the first resin film 301 (see FIG. 5A). Therefore, when the stamper substrate 111 and the resin base plate 101 are separated from each other, the stamper substrate 111 can be peeled off cleanly from the space layer 103 while securing the adhesiveness between the first information recording layer 102 and the space layer 103 (see FIG. 5E).

Next, as illustrated in FIG. 5F, a second information recording layer 104 is formed on the space layer 103. The structure, material, and forming method of the second information recording layer 104 may be similar to those of the first information recording layer 102, for example.

Next, as illustrated in FIG. 5G, a cover layer 109 is formed on the second information recording layer 104. The material for the cover layer 109 is not particularly limited, as long as it is transparent with respect to light for recording/reproduction. For example, an ultraviolet curable resin is used.

For example, the cover layer 109 can be formed by applying a coating containing an ultraviolet curable resin onto the second information recording layer 104 by a spin coating method, followed by irradiation of the applied coating with ultraviolet light. Thus, a multilayer information recording medium having two information recording layers is obtained.

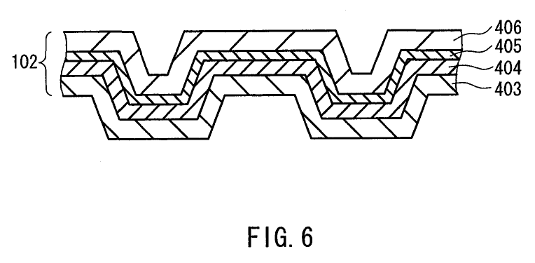

The first information recording layer 102 and the second information recording layer 104 have a structure in which, for example, as illustrated in FIG. 6, a reflective film 403, a first dielectric film 404, a recording film 405, and a second dielectric film 406 are provided in this order from the base plate. Any of these films can be formed using, for example, sputtering, spin coating, deposition, or the like. The material for the reflective film 403 is not particularly limited. For example, AlCr, Ag, Au, or the like is used. The material for the first dielectric film 404 and the second dielectric film 406 is not particularly limited. For example, ZnS or the like is used. The material for the recording film 405 is not particularly limited. For example, TeOPd or the like is used.

Note that, in the present invention, the information recording layer (the first and second information recording layers, etc.) is not limited to the form of FIG. 6. In each information recording layer, at least one of the films other than the recording film of FIG. 6 may be eliminated, or a film other than these films may be included. The multilayer information recording medium of this embodiment may be dedicated to reproduction. In this case, the information recording layer may be formed only of a reflective film containing Al, Ag, Si, Au, or an alloy thereof.

In the example described with reference to FIGS. 5A to 5G, the photosensitive adhesive sheet 300 of Embodiment 1 is used as the material for the space layer. However, instead of this, the photosensitive adhesive sheet 300 of Embodiment 2 may be used.

### EMBODIMENT 5

In Embodiment 5, another exemplary method for producing a multilayer information recording medium of the present invention will be described. In this embodiment, the photosensitive adhesive sheet described in Embodiment 1 is used as a material for a cover layer. In other respects, the method for producing a multilayer information recording medium of this embodiment is similar to that of Embodiment 4.

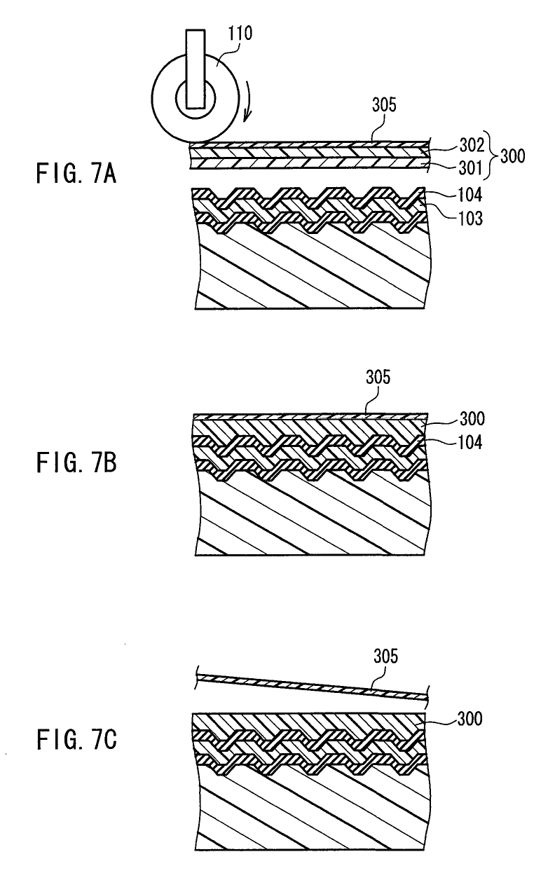

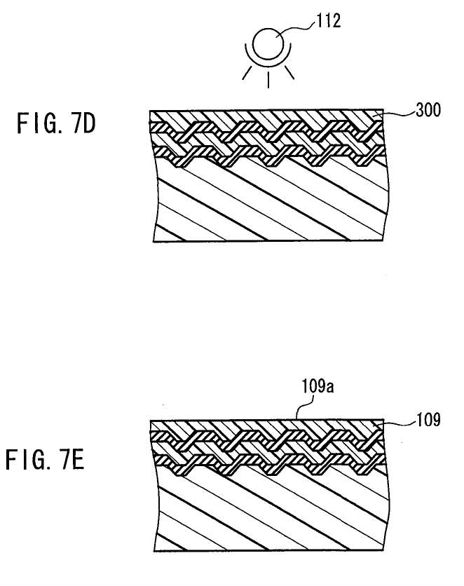

In the method for producing a multilayer information recording medium of the present invention, as in Embodiment 4, the first information recording layer, the space layer 103, and the second information recording layer 104 are formed in this order on the base plate 101 (see FIGS. 5A to 5F). Next, as illustrated in FIG. 7A, the protective sheet 304 is peeled off from the photosensitive adhesive sheet 300 (see FIG. 1), and the photosensitive adhesive sheet 300 is attached to the second information recording layer 104. The first resin film 301 and the second resin film 302 constituting the photosensitive adhesive sheet 300 both contain an ultraviolet curable oligomer. The adhesion of the photosensitive adhesive sheet 300 is performed so that the first resin film 301 of the photosensitive adhesive sheet faces the space layer 103 and the second information recording layer 104.

Next, the photosensitive adhesive sheet 300 is pressed against the second information recording layer 104 using the pressure roller 110. When the photosensitive adhesive sheet 300 is thus pressed, the photosensitive adhesive sheet 300 is deformed in accordance with the uneven surface of the second information recording layer 104, so that the photosensitive adhesive sheet 300 is attached tightly to the second information recording layer 104 (see FIG. 7B). Note that 305 indicates a protective sheet in FIGS. 7A and 7B.

Next, as illustrated in FIG. 7C, after the protective sheet 305 is peeled off from the photosensitive adhesive sheet 300, the ultraviolet lamp 112 (e.g., a halogen lamp, etc.) is used to irradiate the photosensitive adhesive sheet 300 with ultraviolet light to cure the photosensitive adhesive sheet 300 as illustrated in FIG. 7D. By curing, the photosensitive adhesive sheet 300 becomes the cover layer 109 (see FIG. 7E). A surface 109a of the cover layer 109 is obtained by curing the second resin film 302 (see FIG. 7A) containing a large amount of an ultraviolet curable oligomer, so that the surface is hard and is unlikely to be scratched.

### EMBODIMENT 6

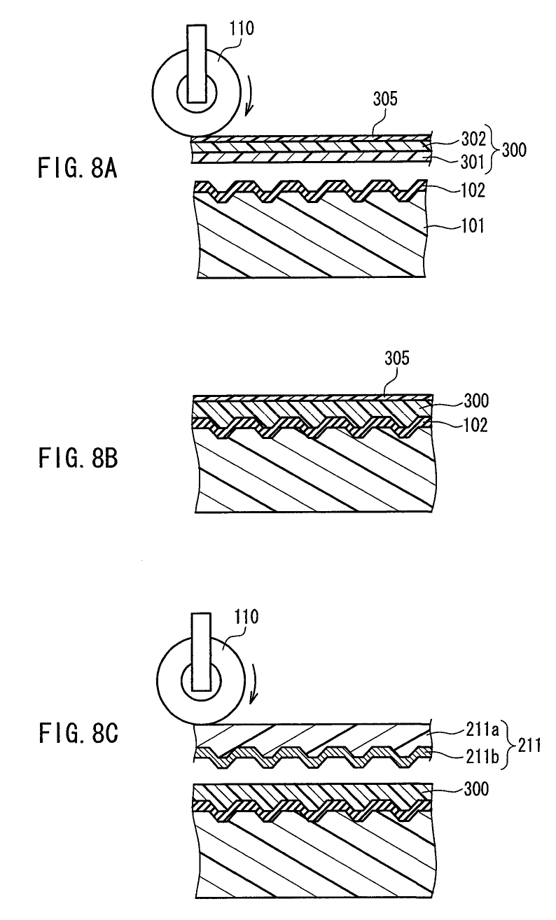

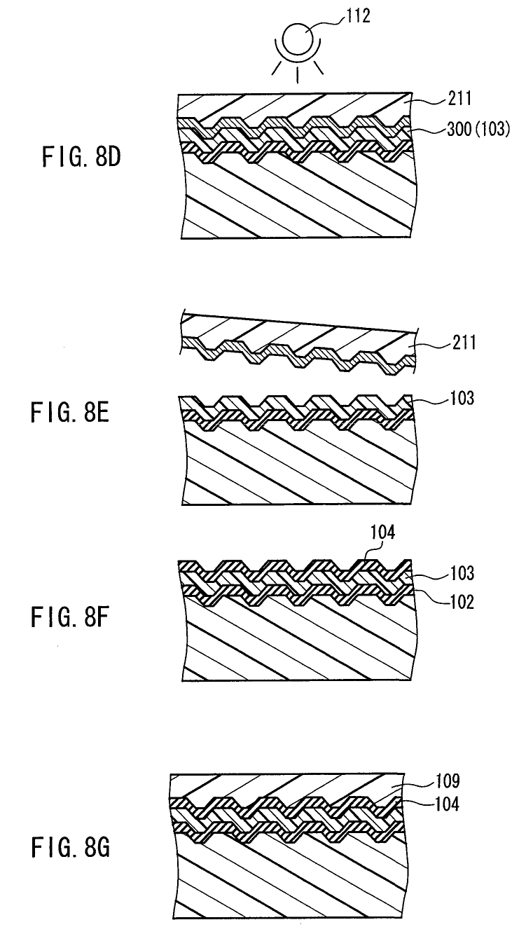

In Embodiment 6, still another exemplary method for producing a multilayer information recording medium of the present invention will be described. In this embodiment, as a stamper substrate, a stamper substrate 211 including a resin substrate 211a and a metal film 211b provided thereon is used. An information surface of the stamper substrate 211 is one surface of the metal film 211b (see FIG. 8C).

In other respects, the method for producing a multilayer information recording medium of this embodiment is similar to the method for producing a multilayer information recording medium of Embodiment 4. Note that the same parts as those described in Embodiment 4 are indicated by the same reference numerals and will not be described.

Initially, as illustrated in FIG. 8A, for example, the first information recording layer 102 is formed on the base plate 101 made of polycarbonate. Next, the protective sheet 304 is peeled off from the photosensitive adhesive sheet 300 (see FIG. 1), and the photosensitive adhesive sheet 300 is attached to the first information recording layer 102. The first resin film 301 and the second resin film 302 constituting the photosensitive adhesive sheet 300 both contain an ultraviolet curable oligomer.

Thereafter, the photosensitive adhesive sheet 300 is pressed using the pressure roller 110. Thereby, the photosensitive adhesive sheet 300 is deformed in accordance with the uneven surface of the first information recording layer 102, so that the photosensitive adhesive sheet 300 is attached tightly to the first information recording layer 102 (see FIG. 8B).

Next, the protective sheet 305 is peeled off from the photosensitive adhesive sheet 300 (see FIGS. 8A and 8B). Thereafter, the stamper substrate 211 having an uneven surface as information to be transferred is attached tightly to the photosensitive adhesive sheet 300. Thereafter, the stamper substrate 211 is pressed using the pressure roller 110. Thereby, the photosensitive adhesive sheet 300 is deformed in accordance with the uneven surface of the stamper substrate 111, so that the information is transferred to the photosensitive adhesive sheet 300 (see FIG. 8C).

The material of the resin substrate 211a included in the stamper substrate 211 is not particularly limited. For example, polycarbonate or the like is used. Also, the material for the metal film 211b is not particularly limited. For example, a metal thin film, such as a silver (Ag) thin film or the like, is used. The transparency of the stamper substrate 211 is inferior to the stamper substrate 111 (see FIG. 5C) made of polycarbonate of Embodiment 4, since the stamper substrate 211 includes the metal film 211b, but the peelability thereof with respect to the space layer is superior thereto.

An appropriate thickness of the metal film 211b is 60 nm or less. When the metal film 211b has a thickness of 60 nm or less, the whole stamper substrate 211 is transparent with respect to light used for curing of the photosensitive adhesive sheet, so that the photosensitive adhesive sheet 300 can be irradiated via the stamper substrate 211 with the light, thereby making it possible to cure the photosensitive adhesive sheet 300.

Next, as illustrated in FIG. 8D, the photosensitive adhesive sheet 300 is irradiated via the stamper substrate 211 with ultraviolet light using the ultraviolet lamp 112 (e.g., a halogen lamp, etc.) to cure the photosensitive adhesive sheet 300. By curing, the photosensitive adhesive sheet 300 becomes a space layer 103. Thereafter, as illustrated in FIG. 8E, the stamper substrate 211 is peeled off from the space layer 103. The adhesive force of the photosensitive adhesive sheet 300 is reduced due to curing. Particularly, in the second resin film 302 having an ultraviolet curable oligomer content (% by weight) higher than that of the first resin film 301, the degree of the reduction of the adhesive force is larger than that of the first resin film 301 (see FIG. 8A). Therefore, when the stamper substrate 211 and the base plate 101 are separated from each other, the stamper substrate 211 can be peeled off cleanly from the space layer 103 while securing the adhesiveness between the first information recording layer 102 and the space layer 103 (see FIG. 8E).

Next, as illustrated in FIG. 8F, a second information recording layer 104 is formed on the space layer 103. The structure, material, and forming method of the second information recording layer 104 may be similar to those of the first information recording layer 102, for example.

Next, as illustrated in FIG. 8G, a cover layer 109 is formed on the second information recording layer 104. The material and forming method of the cover layer 109 may be similar to those of Embodiment 4 or 5. Thus, a multilayer information recording medium having two information recording layers is obtained.

Note that, in the example described with reference to FIGS. 8A to 8G, the photosensitive adhesive sheet 300 of Embodiment 1 is used as the material for the space layer. However, instead of this, the photosensitive adhesive sheet 300 of Embodiment 2 may be used.

### EMBODIMENT 7

In Embodiment 7, still another exemplary method for producing a multilayer information recording medium of the present invention will be described. The method for producing a multilayer information recording medium of this embodiment is similar to the method for producing a multilayer information recording medium of Embodiment 6 except that the number of information recording layers is three in the method for producing a multilayer information recording medium of this embodiment.

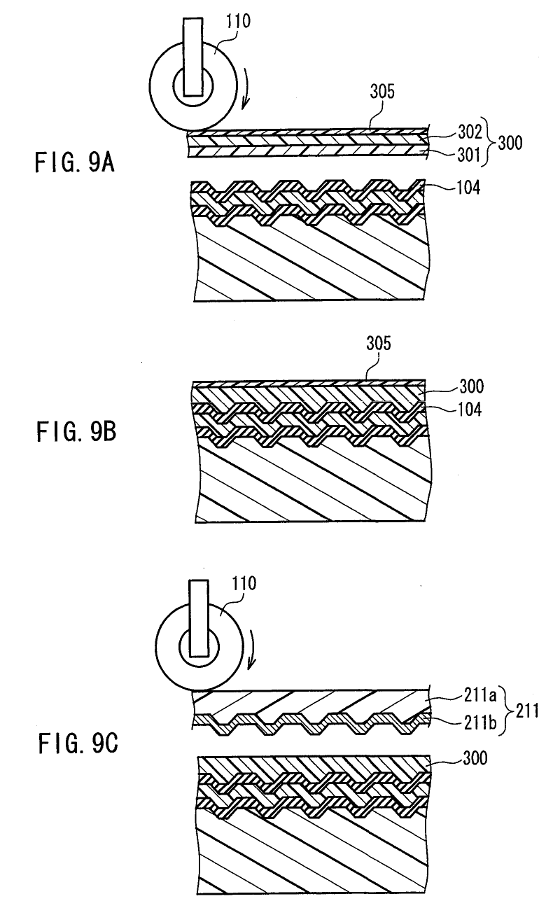

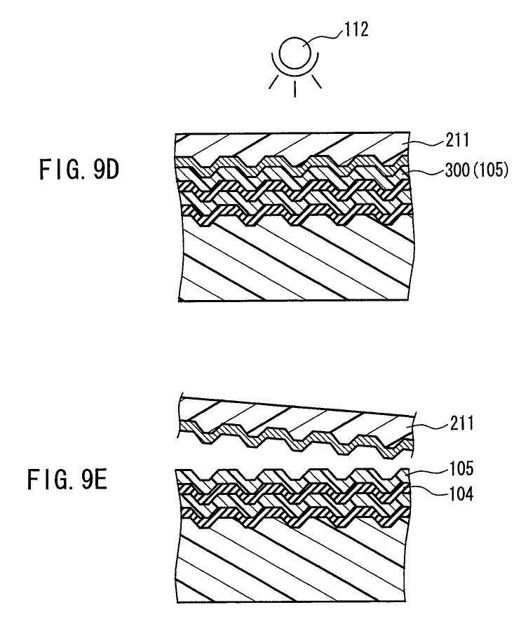

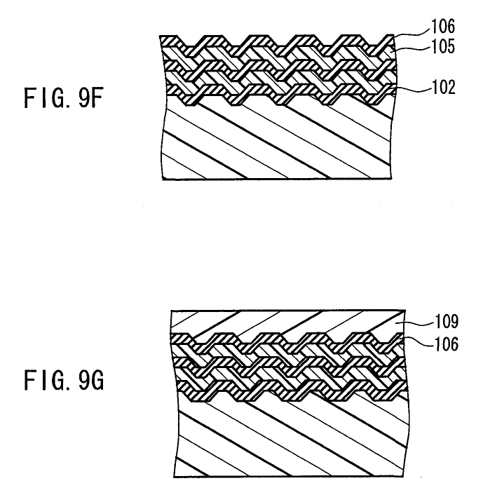

In the method for producing a multilayer information recording medium of the present invention, initially, the first information recording layer, the space layer 103, and the second information recording layer 104 are formed in this order on the base plate 101 (see FIGS. 5A to 5F). Next, the protective sheet 304 is peeled off from the photosensitive adhesive sheet 300 (see FIG. 1), and the photosensitive adhesive sheet 300 is attached to the second information recording layer 104 as illustrated in FIG. 9A. The first resin film 301 and the second resin film 302 constituting the photosensitive adhesive sheet 300 both contain an ultraviolet curable oligomer.

Thereafter, the photosensitive adhesive sheet 300 is pressed using the pressure roller 110. Thereby, the photosensitive adhesive sheet 300 is deformed in accordance with the uneven surface of the second information recording layer 104, so that the photosensitive adhesive sheet 300 is attached tightly to the second information recording layer 104 (see FIG. 9B).

Next, the protective sheet 305 is peeled off from the photosensitive adhesive sheet 300 (see FIGS. 9A and 9B). Thereafter, the stamper substrate 211 having the uneven surface as information to be transferred is tightly attached to the photosensitive adhesive sheet 300. In this embodiment, a stamper substrate similar to that of Embodiment 6 is used. Specifically, the stamper substrate 211 is composed of a resin substrate 211a and a metal film 211b provided thereon, and the uneven surface of the stamper substrate 211 is one surface of the metal film 211b.

Thereafter, the stamper substrate 211 is pressed using the pressure roller 110. Thereby, the photosensitive adhesive sheet 300 is deformed in accordance with the uneven surface of the stamper substrate 211, so that the information is transferred to the photosensitive adhesive sheet 300 (see FIG. 9C).

Next, as illustrated in FIG. 9D, the photosensitive adhesive sheet 300 is irradiated via the stamper substrate 211 with ultraviolet light using the ultraviolet lamp 112 (e.g., a halogen lamp, etc.) to cure the photosensitive adhesive sheet 300. By curing, the photosensitive adhesive sheet 300 becomes a space layer 105.

Next, as illustrated in FIG. 9E, the stamper substrate 211 is peeled off from the space layer 105. The adhesive force of the photosensitive adhesive sheet which is the space layer 105 is reduced due to curing. Particularly, in the second resin film 302 having an ultraviolet curable oligomer content (% by weight) higher than that of the first resin film 301, the degree of the reduction of the adhesive force is larger than that of the first resin film 301 (see FIG. 9A). Therefore, when the stamper substrate 211 and the resin base plate 101 are separated from each other, the stamper substrate 211 can be peeled off cleanly from the space layer 105 while securing the adhesiveness between the first information recording layer 104 and the space layer 105 (see FIG. 9E).

Next, as illustrated in FIG. 9F, a third information recording layer 106 is formed on the space layer 105. The structure, material, and forming method of the third information recording layer 106 may be similar to those of the first information recording layer 102.

Next, as illustrated in FIG. 9G, a cover layer 109 is formed on the third information recording layer 106. The material and forming method of the cover layer 109 may be similar to those of Embodiment 4. Thus, a multilayer information recording medium having three information recording layers is obtained. In addition, by repeatedly performing the formation of a space layer and the formation of an information recording layer, a multilayer information recording medium having four or more information recording layers can be obtained.

### EMBODIMENT 8

In Embodiment 8, an exemplary multilayer information recording medium of the present invention will be described. The multilayer information recording medium of this embodiment has four information recording layers.

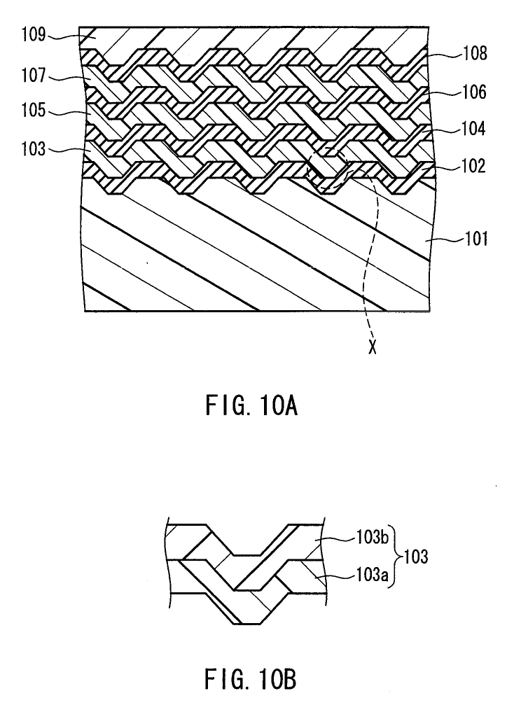

As illustrated in FIG. 10A, in the multilayer information recording medium of this embodiment, a first information recording layer 102, a first space layer 103, a second information recording layer 104, a second space layer 105, a third information recording layer 106, a third space layer 107, a fourth information recording layer 108, and a cover layer 109 are provided in this order on a base plate 101.

In the multilayer information recording medium of this embodiment, the first space layer 103, the second space layer 105, and the third space layer 107 are formed by a method similar to those of Embodiments 4 to 7. Therefore, the space layer provided between a pair of adjacent information recording layers has a layered structure including two or more layers. Also, the space layer has a pair of outermost films having different ultraviolet curable oligomer contents.

Specifically, as illustrated in FIG. 10B, the first space layer 103 includes a second outermost film 103b that contacts the second information recording layer, and a first outermost film 103a that contacts the first information recording layer. The ultraviolet curable oligomer content (% by weight) of the second outermost film 103b is higher than the ultraviolet curable oligomer content (% by weight) of the first outermost film 103a. In other words, the ultraviolet curable oligomer content (% by weight) of one of a pair of the outermost films that is closer to the cover layer 109 is higher than the ultraviolet curable oligomer content (% by weight) of the other that is closer to the base plate 101 (see FIG. 10A).

Also, in the second space layer 105 and the third space layer 107, as in the first space layer 103, the ultraviolet curable oligomer content (% by weight) of one of a pair of the outermost films that is closer to the cover layer 119 is higher than the ultraviolet curable oligomer content (% by weight) of the other that is closer to the base plate 101.

The weight of the ultraviolet curable oligomer substantially does not change between before and after curing. If the ultraviolet curable oligomer content of the second resin film included in the photosensitive adhesive sheet is, for example, 40% by weight or more and 60% by weight or less, the ultraviolet curable oligomer content of the second outermost film 103b is 40% by weight or more and 60% by weight or less. If the ultraviolet curable oligomer content of the first resin film of the photosensitive adhesive sheet is, for example, 10% by weight or more and less than 30% by weight, the ultraviolet curable oligomer content of the first outermost film 103a is 10% by weight or more and less than 30% by weight.

Note that, in the producing process, the photosensitive adhesive sheet of Embodiment 2 may be used as a material for a space layer. In this case, the adhesive polymer content (% by weight) of the first outermost film 103a contacting the first information recording layer 102 is higher than the adhesive polymer content (% by weight) of the second outermost film 103b contacting the second information recording layer 104.

### EXAMPLES

Hereinafter, the peelability of a resin film with respect to a stamper substrate was evaluated while changing the ultraviolet curable oligomer content of the resin film. As the stamper substrate, a base plate made of polycarbonate was used. The resin film was peeled off by pulling the resin film in a direction having an angle of 90° with respect to the adhesion surface. The pulling speed was 300 mm/min. Force (N/cm) required to peel off the resin film was indicated on Table 1.

TABLE 1

| | |
|---|---|
| Content (% by weight) | Peel force |

| | UV curable oligomer | Adhesive polymer | (N/cm) |
|---|---|---|---|
| No. 1 | 10 | 90 | 22 |
| No. 2 | 20 | 80 | 12 |
| No. 3 | 30 | 70 | 4 |
| No. 4 | 40 | 60 | 3 |
| No. 5 | 60 | 40 | 1.5 |

As indicated by Table 1, it was confirmed that, when the ultraviolet curable oligomer content of a resin film is 30% by weight or more, the force required to peel off the resin film is significantly small.

### INDUSTRIAL APPLICABILITY

In the present invention, a photosensitive adhesive sheet that includes a first resin film and a second resin film as outermost films, and in which the ultraviolet curable oligomer content (% by weight) of the second resin film is higher than the ultraviolet curable oligomer content (% by weight) of the first resin film, is used as a material for a space layer. Therefore, after curing, a stamper substrate can be easily peeled off from the second resin film while securing the adhesiveness between the first resin film and a layer which contacts the first resin film. Thereby, in the present invention, it is possible to facilitate production of a multilayer information recording medium.

Also, in the present invention, a photosensitive adhesive sheet that includes a first resin film and a second resin film as outermost films, and in which the adhesive polymer content (% by weight) of the first resin film is higher than the adhesive polymer content (% by weight) of the second resin film, is used as a material for a space layer. Therefore, after curing, a stamper substrate can be easily peeled off from the second resin film while securing the adhesiveness between the first resin film and a layer which contacts the first resin film. Thereby, in the present invention, it is possible to facilitate production of a multilayer information recording medium.

1. A method for producing a multilayer information recording medium including two or more information recording layers and a space layer provided between adjacent information recording layers, the method comprising the steps of:
providing a photosensitive adhesive sheet containing an ultraviolet curable oligomer and an adhesive polymer on a predetermined information recording layer;
attaching a transfer base having an uneven surface as an information surface to the photosensitive adhesive sheet so as to transfer the information of the transfer base to the photosensitive adhesive sheet;
curing the photosensitive adhesive sheet after the transfer of the information so as to cause the photosensitive adhesive sheet to be the space layer; and
peeling off the stamper substrate from the space layer and subsequently forming another information recording layer on the space layer,
wherein the photosensitive adhesive sheet has a layered structure including a first resin film and a second resin film as outermost films, and the second resin film contacting the stamper substrate has an ultraviolet curable oligomer content (% by weight) higher than that of the first resin film contacting the predetermined information recording layer.

2. A method for producing a multilayer information recording medium including two or more information recording layers and a space layer provided between adjacent information recording layers, the method comprising the steps of:
providing a photosensitive adhesive sheet containing an ultraviolet curable oligomer and an adhesive polymer on a predetermined information recording layer;
attaching a stamper substrate having an uneven surface as an information surface to the photosensitive adhesive sheet so as to transfer information of the stamper substrate to the photosensitive adhesive sheet;
curing the photosensitive adhesive sheet after the transfer of the information so as to cause the photosensitive adhesive sheet to be the space layer; and
peeling off the stamper substrate from the space layer and subsequently forming another information recording layer on the space layer,
wherein the photosensitive adhesive sheet has a layered structure including a first resin film and a second resin film as outermost films, and the first resin film contacting the predetermined information recording layer has an adhesive polymer content (% by weight) higher than that of the second resin film contacting the stamper substrate.

3. The method for producing a multilayer information recording medium according to claim 1, wherein the first resin film has an adhesive polymer content (% by weight) higher than that of the second resin film.

4. The method for producing a multilayer information recording medium according to claim 1, wherein the ultraviolet curable oligomer content of the second resin film is 30% by weight or more.

5. The method for producing a multilayer information recording medium according to claim 4, wherein the ultraviolet curable oligomer content of the second resin film is 40% by weight or more and 60% by weight or less.

6. The method for producing a multilayer information recording medium according to claim 5, wherein the ultraviolet curable oligomer content of the first resin film is 10% by weight or more and less than 30% by weight.

7. The method for producing a multilayer information recording medium according to claim 1, wherein the photosensitive adhesive sheet has a two-layer structure.

8. The method for producing a multilayer information recording medium according to claim 1, wherein the photosensitive adhesive sheet has a thickness of 30 μm or less.

9. The method for producing a multilayer information recording medium according to claim 1, wherein the stamper substrate is transparent with respect to light used for curing of the photosensitive adhesive sheet.

10. The method for producing a multilayer information recording medium according to claim 9, wherein the stamper substrate includes the resin substrate and a metal film that is transparent with respect to light used for curing of the photosensitive adhesive sheet, and the information surface of the stamper substrate is one surface of the metal film.

11. The method for producing a multilayer information recording medium according to claim 1, further comprising:
forming a cover layer after the formation of the other information recording layer.

12. The method for producing a multilayer information recording medium according to claim 11, wherein a photosensitive adhesive sheet including a first resin film and a second resin film as outermost films is used as a material for the cover layer.

13. The method for producing a multilayer information recording medium according to claim 12, wherein, in the cover layer forming step, the photosensitive adhesive sheet is disposed so that the first resin film of the photosensitive adhesive sheet used for formation of the cover layer faces the other information recording layer.

14. A photosensitive adhesive sheet for use in production of a multilayer information recording medium including two or more information recording layers and a space layer provided between adjacent information recording layers, the photosensitive adhesive sheet comprising:
a first resin film as one outermost film; and
a second resin film as the other outermost film,
wherein the first resin film and the second resin film both contain an ultraviolet curable oligomer and an adhesive polymer, and the second resin film has an ultraviolet curable oligomer content (% by weight) higher than that of the first resin film.

15. A photosensitive adhesive sheet for use in production of a multilayer information recording medium including two or more information recording layers and a space layer provided between adjacent information recording layers, the photosensitive adhesive sheet comprising:
a first resin film as one outermost film; and
a second resin film as the other outermost film,
wherein the first resin film and the second resin film both contain an ultraviolet curable oligomer and an adhesive polymer, and the first resin film has an adhesive polymer content (% by weight) higher than that of the second resin film.

16. (canceled)

17. A multilayer information recording medium comprising:
a base plate;
a first information recording layer provided on the base plate;
a space layer provided on the first information recording layer, and containing an ultraviolet curable oligomer and an adhesive polymer; and
a second information recording layer provided on the space layer,
wherein the space layer has a layered structure including a first outermost film contacting the first information recording layer and a second outermost film contacting the second information recording layer, and the second outermost film has an ultraviolet curable oligomer content (% by weight) higher than that of the first outermost film.

18. A multilayer information recording medium comprising:
a base plate;
a first information recording layer provided on the base plate;
a space layer provided on the first information recording layer, and containing an ultraviolet curable oligomer and an adhesive polymer; and
a second information recording layer provided on the space layer,
wherein the space layer has a layered structure including a first outermost film contacting the first information recording layer and a second outermost film contacting the second information recording layer, and the first outermost film has an adhesive polymer content (% by weight) higher than that of the second outermost film.
